(19) United States
(12) Patent Application Publication
(10) Pub. No.: US 2006/0083861 A1
(43) Pub. Date: Apr. 20, 2006

(54) Method of reducing loss in power transmission systems, electrical systems and electronics

(76) Inventor: Anthony A. Gedeon, St. Augustine, FL (US)

Correspondence Address: Charles J. Prescott, P.A., Suite 115, 2033 Wood Street, Sarasota, FL, 34237, US

(21) Appl. No.: 11/112,542

(22) Filed: Apr. 22, 2005

Related U.S. Application Data
(60) Provisional application No. 60/565,223, filed on Apr. 24, 2004.

(51) Int. Cl. B05D 5/12

(52) U.S. Cl. 427/402; 427/58

(57) ABSTRACT

Advances in oligomeric siloxane coatings applied as reactive silanols have arisen in the past several years that offer opportunities to solve problems that could not be addressed with traditional coating materials and methods. Although this class of new coatings is normally cited only for their corrosion resistance, they also exhibit the unusual phenomenon of having electron deficient surfaces. The electron deficient surface is formed as the coating cures in that organic radical groups from the silanes used in the formulation are forced to the surface of the coating. The silica atoms in the silicon oxygen structure below retain electrons skewing the electron cloud downward creating an electron deficient or net positively charged surface. The resultant surface discourages light hydrogen bonding of contaminants, thereby reducing leakage paths, particularly on insulators. Further, the surfaces to do not corrode for very extended periods of time as the siloxane coating covalently bonds with oxides or hydroxyl groups on the surfaces coated, using up the available chemical activity and providing a non-porous barrier to connections. This unique positively charged surface further exhibits both hydrophobic and oleophobic qualities allowing rain water or heavy dew to clean the system from oily contaminants, organic compounds from combustion or industrial processes, microbial and mold growth, and salt.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to a method of reducing loss in power transmission systems, electrical systems, and electronics by coating the system components, connections, insulators, and wires with a catalyzed or pre-catalyzed reactive silanol for reduced power loss.

2. Description of Related Art

Siloxane coatings have been granted three US patents known to applicant: Schutt et al., in U.S. Pat. No. 5,929,159, Oligomeric silicon coating compositions, articles coated therewith and method for forming coating composition and coated articles based thereon. Schutt in U.S. Pat. No. 6,432,191, Silane-based, coating compositions, coated articles obtained there from and methods of using same and Schutt, et al., in U.S. Pat. No. 6,451,382, Method for improving heat efficiency using silane coatings and coated articles produced thereby.

The content of matter formulas described in these patents and any current or future derivative formulas for reactive silanols where such materials are applied using the methods defined herein for the purposes claimed herein are incorporated by reference. While not wishing to be bound by the following formulae provided for information, examples of reactive silanol compositions as described in the referenced Schutt et. al. patents are any coating, polish, primer, penetrant, sealer, or surface modification treatment comprised of an aqueous or non-aqueous oligomeric low molecular weight silanol formed by admixing (a) at least one silane of the formula (1)
R.sup.1.sub.n Si(OR.sup.2).sub.4−n (1)
where R.sup.1 represents a C.sub.1-C.sub.6 alkyl group, a C.sub.6-C.sub.8 aryl group or a functional group including at least one of vinyl, acrylic, amino, mercapto, or vinyl chloride functional groups, R.sup.2 represents a C.sub.1-C.sub.6 alkyl or acetyl group and n is a number of 1 or 2;
(b) silane condensation catalyst, and
(c) C.sub.2-C.sub.4 alkanol solvent, and;
(d) (ii) colloidal aluminum hydroxide, (iii) metal alcoholate of formula (2):
   M(OR.sup.3).sub.m (2)
   where M is a metal valence 2, 3 or 4, or mixture of two or more such metals;
   R.sup.3 represents a C.sub.1-C.sub.6 alkyl group,
m represents a number or 2, 3 or 4, or mixture of (ii) and (iii); and
(e) water;
   or, an aqueous or non-aqueous oligomeric silanol composition formed by admixing
(a) at least one silane of the formula (1)
   R.sup.1.sub.n Si(OR.sup.2).sub.4−n (1)
   where R.sup.1 represents a lower alkyl group, a C.sub.6-C.sub.8 aryl group or a functional group including at least one of vinyl, acrylic, amino, mercapto, or vinyl chloride functional groups;
(b) silane condensation catalyst, and
(c) lower alkanol solvent, and optionally, one or more of
(d) colloidal aluminum hydroxide;
(e) metal alcoholate of formula (2):
   M(OR.sup.3).sub.m (2)
   where M is a metal valence 2, 3 or 4, or mixture of two or more such metals;
R represents a lower alkyl group; and,
m represents a number or 2, 3 or 4;
(f) silica component selected from the group consisting of alkali metal silicate, ethyl orthosilicate, ethyl polysilicate, and colloidal silica dispersed in lower alkanol;
(g) color forming silanol condensation catalyst;
(h) epoxysilane;
(i) ultrafine titanium dioxide ultraviolet light absorber;
(j) water;
(k) co-solvent;
   or any reactive silanol pre-catalyzed (hydrolyzed) by adding water and additives to silanes and inducted for at least five, but not more than 20 minutes, and then diluted with solvent such as, but not limited to, lower alkanols such as isopropyl and ethyl alcohol to inhibit further polycondensation and cross-linking so as to be subsequently applied as 1-part reactive silanol that can be applied to a surface by spraying, brushing, or wiping; and which then optionally can be cross-linked into a polysolixane film by applying water and, preferably, water acidified with acetic acid or a mineral acid such as boric acid or other condensation additive where that water or aqueous mixture is mechanically buffed into the silanol layer using a wiping cloth, preferably, a microfiber polishing cloth or mechanical buffing wheel or similar device.

The applications disclosed herein represent a significant advance in the state-of-the-art that overcome the limitations of traditional corrosion control treatments. Organic coatings (paints) are unsuitable for protecting power transmission components because they fail at elevated temperature, are insulators, and can act as a fuel in an electrical fire. Further, organic coatings and integrated circuit conformal coatings support the growth of mold, mildew, and algae that can bridge insulators. Thin film corrosion preventive compounds (CPCs), water displacing compounds (WDCs), and volatile corrosion inhibitors (VCls) may be thin enough to allow conduction, but are very short lived. Such coatings do nothing to prevent the growth of mold, mildew, and algae that can bridge insulators. Siloxane coatings applied as reactive silanol as described herein are thin enough to conduct current while providing long term corrosion resistance, functionality at high temperatures and thermal cycling, resistance to contamination from salts, oils, and air borne pollutants, and resistance to formation of mold, mildew, fungus, algae, and some bacteria.

Silane technology dates back to the 1930's. Silicon-based or silicon-containing coatings and penetrants that can be applied and cured at ambient temperatures include silanes (typically alkylalkoxysilanes or alkyltrialkoxysilanes), siloxanes (typically oligomerous alkylalkoxysiloxanes or silsesquioxanes), silicates (including ethyl silicates, sodium silicates, and potassium silicates), methyl siliconates, blends of the above, and hybrid organic-inorganic paints and coatings including silicone alkyds, epoxy-siloxane coatings and acylic-siloxane coatings. However recent developments have allowed for the formation of thin corrosion resistant siloxane coatings applied as sols of reactive silanol. In a recent corrosion symposium, a good history of recent developments was given by one of the inventor's past employees on the background of siloxanes, N. Andrew Greig, of Arlington, Va.; “A Brief Overview of Reactive Silanes and other Siloxane Coatings as Corrosion Preventatives”, presented at the Rust 2002 conference.

“In the early 1970s, Harold A. Clark of Dow Corning Corporation patented a variety of siloxane systems for lens coatings, fire-retardant binders for fire insulation, and a new variety of paints (see U.S. Pat. Nos. 3,944,762, 3,976,497, and related patents). Clark's invention involved generating RSi(OH)₃ silanols in situ by adding trialkoxysilanes in an isopropyl alcohol-water carrier to an acidic dispersion of colloidal silica (Arkles, 607). This resulting sol condenses into a siloxanol polymer gel forming Si—O—Si chains that further cures to form a hard, adherent layer of silsesquioxanes (RSiO2/3). Clark created paint coatings by adding a variety of pigments to form flame-resistant paints and high-gloss enamels, to name a few.

When the Clark patents from 1976 expired, Dr. John Schutt of NASA Goddard and Tony Gedeon developed a new siloxane approach to overcome a weakness in the original Dow patents. Specifically, their U.S. Pat. No. 5,929,159 in July 1999 claimed that use of colloidal silica, “especially when used in or near the amounts contemplated by the above Dow Corning (Clark) patents, renders the coatings porous or microporous and drastically reduces the corrosion resistance of the coatings.” Their approach was to replace colloidal silica with divalent cations, particularly, Ca+2.

Again quoting from the patent:

Generally, when the silicon atom is both trifunctionally and quadrifunctionally hydroxylated, the resulting siloxane network accommodates minimally the passage of water vapor and in some circumstances also the passage of water as well as oxygen. Because of this property, bonding resulting from the hydroxylation at a metallic interface is incomplete and corrosion can occur. The present coating compositions better utilize the reactivity of the silanol moiety with substrate oxy and hydroxy species and promote the formation of a contiguous interfacial layer unaffected by surface and bulk diffusion of water, water vapor and oxygen. This is accomplished, at least in part, by replacing all or most of the colloidal silica in formulations of the type described in the Dow Corning (Clark) patents mentioned above with divalent metal (M.sup.+2) ions, such as, for example, Cu.sup.+2, Zn.sup.+2, Ca.sup.+2, Co.sup.+2, and Mn.sup.+2.

Other objectives of the new coating cited in the patent include:
to provide abrasion resistant coating compositions suitable for metallic and non-metallic surfaces.
to provide transparent, glass-like abrasion-resistant and corrosion resistant coating compositions as well as coated articles.
to provide such improved coating compositions as aqueous formulations with low volatile organic component (VOC) levels and, therefore, environmentally acceptable.
to provide such coating compositions which may be prepared easily and economically and are easy to apply to various types of substrates.
to develop a coating composition suitable for coating marine surfaces, such as aluminum boat hulls, to render the surfaces corrosion resistant in a salt water environment.”

The resultant condensed organic-inorganic hybrid layer is thin (5μ-1 mil), transparent, and hard (pencil hardness 11 H). Because the molecular size of the silanols before they cure into siloxane oligomers is so small, the sol penetrates pores in the substrate to achieve better sealing and bonding. The substrate can be a metal, non-metal, or an organic coating.”

### BRIEF SUMMARY OF THE INVENTION

This invention is directed to a method of reducing loss in power transmission systems, electrical systems, and electronics by coating the system components, connections, insulators, and wires with a catalyzed or pre-catalyzed reactive silanol for reduced power loss.

It is therefore an object of this invention to provide a method of reducing loss in power transmission systems, electrical systems and electronics.

In accordance with these and other objects which will become apparent hereinafter, the instant invention will now be described.

### DETAILED DESCRIPTION OF THE INVENTION

As oligomeric siloxane coatings polymerize, the silica atoms rotate to allow the larger organic groups upward mobility to the surface of the coating. The silica atoms in the siloxane coating matrix strongly attract electrons, while the surface organic groups easily give up electrons. This phenomenon allows the electron cloud to skew downward, effecting an electron deficient surface that has a net positive charge for the life of the coating. The coating of any of the aforementioned and virtually any surface allows this unique property to form. Positive surface charge effects can be seen in multi-part and catalyzed and partially catalyzed one part siloxane coatings and are envisioned herein as part of the invention.

Siloxane coatings are also very resistant to micro-organisms because of the very tight silica oxygen polymer formed, with the small sub-nanometer sized molecules, with the positive charged surface. In testing at Microbac Laboratories, Venice Fla., running the ASTM G-21 test for mold spores showing a perfect rating for lack of spores on a sample coated with a catalyzed siloxane coating against a control.

Samples of Resistant Staff, Legion Ella, and Tuberculosis were inoculated onto a test surface at a South Carolina hospital test lab. The samples were placed in Petrie Dishes for standard nutrient growth tests. In all tests, the living inoculated agents were dead and did not multiply.

While not wishing to be bound by formulae provided for information, this invention is based on the discovery that reactive silanol compositions such as those described in the referenced Schutt et. al. patents when catalyzed or partially catalyzed and applied to the methods described herein cure into a dense, siloxane film where organic moieties are oriented toward the surface of the film causing a permanent, positive surface potential. The silicon atoms in the siloxane coating matrix strongly attract electrons, while the surface organic groups easily give up electrons. This provides an electron deficient surface that has a net positive charge for the life of the coating.

Oligomeric Siloxane coatings can be of two basic types. The first are the type of siloxane that is a multi-part catalyzed system as cited in the patents referenced or an organo-silane catalyzed in a similar manner. The second is a partially catalyzed siloxane coating where moisture is absorbed from the air or artificial means to complete hydrolysis of component silanes upon application, to form a very thin coating that is not as durable as a multi-part catalyzed coating, but can be easily applied by untrained consumers or maintenance personnel as a single part system, usually in a simple spray bottle.

Such coatings applied to any of the surfaces stated, will provide an electron deficient surface, in effect, a positively charged surface, that will not provide a media for multiplication of viruses and bacteria, and will through their structure of small molecules and hydrophobic and oleo phobic surfaces provide an ease of cleaning of residues for a decontamination process.

Organo-siloxanes and silanes are also envisioned under this invention, however, they do not exhibit the compact structure that oligomeric siloxanes exhibit due to molecule size and would be deficient in the cleaning ability as they would be more susceptible to penetration and adherence of microbial growth, and could also be less polar on their surface displaying less positive surface charge. Also, if organo-silane compounds are used that may exhibit equal or greater surface charge, the permanence of the surface would be somewhat reduced from the performance of oligomeric siloxanes applied as sols of reactive silanol.

The invention will now be illustrated by the following non-limiting methods and articles produced thereby. It is understood that these methods and preferred embodiments are given by way of illustration only and without intent to limit the invention thereto.

Power system components are cleaned with water, high pressure water or hot high pressure water, soap and water, organic cleaning solvents, or by abrasion. Excess oxidation is generally removed by abrasion. Electrical boxes can be de-energized, cleaned by dry ice blasting, forced air, aqueous or non-aqueous cleaners and dried, or a combination of cleaning procedures. Integrated circuit cards individually or as installed in electronic system boxes can be de-energized, cleaned by forced air, aqueous or non-aqueous cleaners and dried, or both. In all cases, the siloxane coating is wiped, sprayed, spritz bottle sprayed, rolled, or brushed on the surface and allowed to cure in dry air.

The method of mixing (catalyzation) and application of reactive silanols of the types described in or derived from the prior art cited herein to achieve contaminant-, corrosion- and organo-resistant surfaces involves the following steps:
1. Hydrolvzation of a specific alkoxysilane or a blend of alkoxysilanes with water to produce active silanol groups where R is a nonhydrolyzable organic substituent such as, but not limited to, a methyl (CH.sub.3), ethyl (C.sub.2H.sub.5), propyl (C.sub.2H.sub.7), vinyl (C.sub.2H.sub.3), or phenyl (C.sub.6H.sub.5) group and where the hydrolyzable group is, but not limited to at least one and preferably three, methoxy (OCH.sub.3), ethoxy (OC.sub.2H.sub.5), or chloro (Cl) group(s) as depicted in formula (3)
   R—Si—(OCH.sub.3).sub.+3H.sub.2O→R—Si—(OH).sub.3+3CH.sub.OH⇑ (3)

The water for hydrolyzation can be added as reagent-grade water, can come from the atmosphere, or be absorbed from the surface of the material being coated. Hydrolyzation releases an alcohol by-product, such as methanol or ethanol, which is released as a gas during open pot mixing. Open pot mixing is preferred to force formula (3) to the right (complete hydrolyzation) and to allow controlled release of alcohols, other solvents, or both.
2. Polycondensation to form predominantly linear oligomers of polysilanols (siloxanols)(formation of siloxane bonds) to form a reactive silanol sol per formula (4): 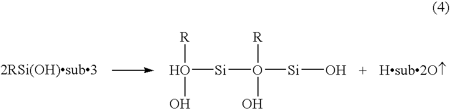
. . . and so on for 30-minute to 12-hour induction period.

Reactive silanol sols as applied to methods described herein typically have isopropyl alcohol (IPA), ethyl alcohol, propylene glycol ethers, or other solvents added to reduce viscosity for surface penetration and wetting, and to accelerate evaporation of water. Curing agents such as, but not limited to, tetrabutoxytitanate and wetting agents may also be added to accelerate film formation and substrate bonding. Pigments, dyes, water soluble additives such as corrosion inhibitors, and chemically bonded additives such as corrosion inhibitors may be added to produce distinctive film properties, provided the additions are not so great to disrupt the development of a low-porosity interpenetrating network of organosolixanes with organic moieties oriented toward the surface.

Application and Curing

The reactive silanol sol is applied to a surface and covalently bonds with surface oxides and hydroxides to form metal oxysilicates, condenses, and cross-links into amorphous interpenetrating network of siloxanes with organic moieties oriented toward the surface of the film per formulae (5) . . .

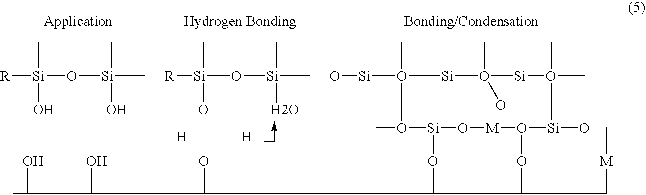

Oxidized Metal or Aged Non-Metallic Substrate

Note that water is both a reactant (hydrolyzation) and a reaction product (polycondensation and bonding with surface oxides and hydroxides). Acetic acid, boric acid, or other acids can be used to accelerate hydrolyzation and keep the structure open long enough to allow reaction product water and solvents to escape during substrate bonding.

Another method of producing polysiloxane films with reactive silanols involves partially catalying silanes with water and additives and inducting for at least five, but not more than 20 minutes, and then diluting with solvent such as, but not limited to, isopropyl alcohol to inhibit further polycondensation and cross-linking so as to be subsequently applied as 1-part reactive silanol that can be applied to a surface by spraying, brushing, or wiping; and which then optionally can be cross-linked into a polysolixane film by applying water and, preferably, water acidified with acetic acid or a mineral acid such as boric acid or other condensation additive that is mechanically buffed into the silanol layer using a wiping cloth, preferably, a microfiber polishing cloth or mechanical buffing wheel or similar device.

Although not wishing to be bound by any particular theory of operation, this invention notes that the structure of the cured film, namely a thin layer of interpenetrating polysiloxanes with organic moieties predominately oriented toward the surface, accounts for the unique properties afforded to substrates treated with reactive silanols and that this structure depends not only on the Schutt et. al, content-of-matter patents cited as prior art, but on the mixing and application of the reactive silanol. Specifically:
Water up to 50% of the catalyzed silane-water-additives mixture, but preferably no more that 33% of the catalyzed mixture can be added in excess of the amount stoichiometrically needed for complete hydrolyzation of precursor alkoxysilanes to control the rate of polycondensation of oligomeric silanols and to improve wetting and application viscosity.
The post-catalyzation induction time can be adjusted to allow complete hydrolyzation of all precursor silanes and to allow formation of oligomers of polysilanols, but limited so that the mixture does not gel or form excessive molecular weight polymers (100,000 atomic mass units or greater) of reactive silanols that interfere with proper film formation
Induction times and curing times can be modified by varying the amount and types of curing agents and acids used
The blend of added solvents can be such that formation of cyclic silanols is inhibited and may be blended to achieve longer drying times to allow for overlapping coats (called wet line control)
Solvents can be added to the inducted mixture to reduce viscosity for application and increase pot life, but too much added solvent, including water, interferes with film formation and substrate bonding described herein to achieve contamination-resistant and easy-clean surfaces.

The thin, glass-like film is clear and, unlike clear organic coatings, does not yellow, oxidize, or lose gloss. Si—O bonds are not only 130% stronger than C—C bonds found in organic coatings, but the polysiloxane structure is almost fully oxidized making it thermodynamically stable. The organic substituents are largely excluded from cross-linking reactions so tend to rotate to the surface of the film as it cures. This property of reactive silanols not only accounts for the varying surface properties that can be engineered, but explains why reactive silanols should be applied only in very thin films. If the sol is allowed to pool into thick deposits, the organic groups cannot orient to the film-air interface causing incomplete cross-linking of the film.

### EXAMPLE 1

### Power Distribution System

The US Navy Southeastern Region, at NAS Jacksonville, and the EPA Division of Air Quality, Raleigh N.C., instituted a test program of this technology. Power distribution systems on military bases are required to have multiple feed redundancies to insure military operations in any emergency. Unlike commercial distribution systems, the power feeds on military bases have long sections of transmission lines, above and below ground, that feed substations such that loads can be fed from redundant sources, generally double, triple or quadruple redundancy. Therefore, there exists power distribution on said bases that can be monitored from input and output to determine loss without the normal power drops and transformers that populate commercial feed systems. The Navy and EPA have instituted a program at NAS Jacksonville and NS Mayport in Jacksonville, Fla., to test said technology for the losses in power transmission systems. The NS Mayport test has coastal salt, aircraft and ship exhaust exposure. The NAS Jacksonville test has predominantly aircraft exhaust exposure.

Installation of a siloxane coating was performed according to said embodiment. Jacksonville Electric Authority (JEA), the city municipal power supplier, and the existing base maintenance contractor on both bases performed the work. The distribution coated was a high voltage three phase feeder from the power company substation to substations at remote parts of the base constituting runs from 3000 feet to 7000 feet. JEA installed state of the art logging power meters at both ends of the sections under test with accuracies in the tenths of a percent to determine power loss. In the testing one phase was left untouched as a control, the second phase was cleaned using said procedures, and the third phase was cleaned and coated to using said procedures. This allows comparison of an existing system to one that is cleaned (similar to a new system), to one that is treated as set forth herein.

In the first 24 hours of operation of the metering equipment at NAS Mayport, with only 70% of the test line coated, the cleaned only phase used 17.68% less power than the control, and the cleaned and coated phase used 42.00% less power than the control. After 44 hours of monitoring, the cleaned only phase used 17.09% less power than the control, and the cleaned and coated phase used 41.62% less power than the control showing consistent data. Because the control transmission phase has both corrosion and contamination, while the other two were cleaned of corrosion. The cleaned only strand has not had time to corrode thus the difference is due to contamination. The ratio of 17% (40% savings) decrease in power loss from the control to the cleaned only phase for contamination and corrosion; compared to 25% (60% savings) from the cleaned only to the cleaned and coated phase; suggests that an additional 60% of the 40% or an additional 24% of savings is due to contamination of the total of 42% from control to cleaned and coated phase. Thus, approximately 84% of losses in the test power transmission system is due to contamination versus corrosion. The reduction of loss by the invention is significant.

### EXAMPLE 2

### Electrical Components

The conductive base of a light bulb was cleaned and treated with a single coat of catalyzed reactive silanol. The base was subjected to 2000 hours of neutral salt fog exposure and showed no corrosion. The base was then fitted with the evacuated glass bulb. The light bulb was then subjected to an additional 1000 hours of neutral salt fog exposure. When energized, the bulb provided full illumination.

### EXAMPLE 3

### Waterfront Electrical Boxes and Components

In a demonstration for the US Navy, pier-mounted electrical boxes and other power transmission components were de-energized and cleaned by brushing to remove contaminants, corrosion products, and salts. The interior components and the housings were treated with a single coat or catalyzed reactive silanol. Over a year later, the components and electrical systems remained free of corrosion and functioned with no noticeable losses.

### EXAMPLE 4

### Electronics

Two identical electronics systems enclosed in anodized aluminum boxes were identically cleaned by soap and water and forced air dried. One box was coated with catalyzed reactive silanol inside and out. Both boxes were then exposed to 36 hours of neutral salt fog. The components, wiring, and housing were noticeably cleaner and more corrosion free on the coated box than on the uncoated box.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A method of reducing loss in power transmission/electrical systems or electronic systems and extending the life and performance said systems and their components by coating lines, substations, capacitors, insulators, connections, switches, supports, existing coatings, and other all other system components, above or below ground, by coating said components as an overcoat to other coatings, directly over metal, over combinations of metal and other coatings, over ceramics used as insulators, or over plastics or composites used as insulators with catalyzed or partially catalyzed reactive silanols to create a net positive surface charge on the coating to reduce electrical leakage to ground or other phases losses from oily contaminants, organic compounds from combustion or industrial processes, microbial and mold growth, salt and reduced corrosion that can increase resistance.

2. A method of rendering surfaces of all types resistant to mold and other organic growth that can provide conductive paths across insulators and corrode connections thereby reducing power transmission/electrical system losses or reducing microprocessor component and integrated circuit failures or signal losses by coating said components as an overcoat to other coatings, directly over metal or combinations of metal and other coatings, over ceramics used as insulators, or over plastics or composites used as insulators with catalyzed or partially catalyzed reactive silanol(s) to create a net positive surface charge on the coating to reduce electrical leakage to ground or other phases (losses) and reduce corrosion that can increase resistance.

3. A method of reducing salt build up on power transmission, electrical system or electronic system components and housings in coastal regions that can provide conductive paths across insulators and corrode connections thereby reducing system power/signal losses and of reducing contamination of said systems by oily, sooty, or chemical contaminants near airports, industrial areas, chemical plants, freeways, power plants and other areas that experience combustion exhaust exposure, organic industrial emissions, or inorganic conductive emissions by coating said components as an overcoat to other coatings, directly over metal or combinations of metal and other coatings, over ceramics used as insulators, or over plastics or composites used as insulators with catalyzed or partially catalyzed reactive silanol(s) to create a net positive surface charge on the coating to reduce electrical leakage to ground or other phases (losses) and reduce corrosion that can increase resistance.
